(19) United States
(12) Patent Application Publication
(10) Pub. No.: US 2019/0128596 A1
(43) Pub. Date: May 2, 2019

(54) DOOR SENSOR FOR REFRIGERATION APPLIANCES

(71) Applicant: Littelfuse, Inc., Chicago, IL (US)

(72) Inventors: Gwenn GMEINDER, Columbus, WI (US); Brad BENSON, Chicago, IL (US); Dave HAACK, Chicago, IL (US); Seong-Jae LEE, Mount Prospect, IL (US); Stephen E. KNAPP, Chicago, IL (US)

(21) Appl. No.: 16/175,117

(22) Filed: Oct. 30, 2018

Related U.S. Application Data
(60) Provisional application No. 62/578,910, filed on Oct. 30, 2017.

(51) Int. Cl. F25D 27/00; G01D 5/14; F25D 11/02; F25D 23/02; F25D 29/00

(52) U.S. Cl. CPC F25D 27/005; G01D 5/142; F25D 29/003; F25D 23/028; F25D 11/02

(57) ABSTRACT

A refrigeration appliance including a frame defining a refrigeration compartment, a door connected to the frame and having a door gasket with a magnet disposed therein, the door movable between an open position in which the refrigeration compartment is accessible and a closed position in which the door covers the refrigeration compartment, and a tunneling magnetoresistance (TMR) door sensor disposed within the frame, wherein the magnet is positioned adjacent the TMR door sensor when the door is in the closed position.

### CROSS REFERENCES TO RELATED APPLICATIONS

This application claims the benefit of U.S. Provisional Patent Application No. 62/578,910, filed Oct. 30, 2017, the entirety of which is incorporated herein by reference.

### BACKGROUND

### Field

The present invention relates generally to the field of sensing devices, and relates more particularly to a tunneling magnetoresistance (TMR) door sensor for refrigeration appliances.

### Description of Related Art

A typical refrigeration appliance (e.g., refrigerator, freezer, beverage cooler, etc.) includes a pushbutton door switch that is built into the frame of the appliance. The door switch is physically depressed by a door of the appliance when the door is closed. Thus, when the pushbutton switch is released, a control unit within the appliance may determine that the door has been opened and may perform certain operations accordingly. For example, a light within a refrigeration compartment of the appliance may be turned on, a compressor of the appliance may be activated, etc.

A shortcoming associated with conventional pushbutton door switches is that they include moving, mechanical components that may become worn and/or damaged over the course of use, which may necessitate repair or replacement of a door switch. Furthermore, conventional pushbutton door switches protrude from the frames of refrigeration appliances and thus detract from the overall aesthetic appearance of an appliance.

It is with respect to these and other considerations that the present improvements may be useful.

### BRIEF DESCRIPTION OF THE DRAWINGS

FIG. 1 is a front view illustrating a refrigerator in accordance with an exemplary embodiment of the present disclosure; and

FIG. 2 is a perspective view illustrating a tunneling magnetoresistance door sensor in accordance with an exemplary embodiment of the present disclosure.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

An exemplary embodiment of a refrigeration appliance in accordance with the present disclosure may include a frame defining a refrigeration compartment, a door connected to the frame and having a door gasket with a magnet disposed therein, the door movable between an open position in which the refrigeration compartment is accessible and a closed position in which the door covers the refrigeration compartment, and a tunneling magnetoresistance (TMR) door sensor disposed within the frame, wherein the magnet is positioned adjacent the TMR door sensor when the door is in the closed position.

Another exemplary embodiment of a refrigeration appliance in accordance with the present disclosure may include a frame defining a refrigeration compartment, a refrigerator door connected to the frame and having a door gasket with a magnet disposed therein, the refrigerator door movable between an open position in which the refrigeration compartment is accessible and a closed position in which the refrigerator door covers the refrigeration compartment and the door gasket forms a seal between the refrigerator door and the frame, the magnet holding the door gasket to the frame in the closed position, a tunneling magnetoresistance (TMR) door sensor disposed within the frame, wherein the magnet is positioned adjacent the TMR door sensor when the door is in the closed position, and a control unit connected to the TMR door sensor and to a light within the refrigeration compartment, wherein the control unit is adapted to detect a decrease in a resistivity of the TMR door sensor and resultantly activate the light when the door is opened from the closed position.

### DETAILED DESCRIPTION

An exemplary embodiment of a refrigeration appliance having a tunneling magnetoresistance door sensor in accordance with the present disclosure will now be described more fully hereinafter with reference to the accompanying drawing. The refrigeration appliance of the present disclosure may, however, be embodied in many different forms and should not be construed as being limited to the embodiments set forth herein. Rather, these embodiments are provided so that this disclosure will convey certain exemplary aspects of the refrigeration appliance to those skilled in the art.

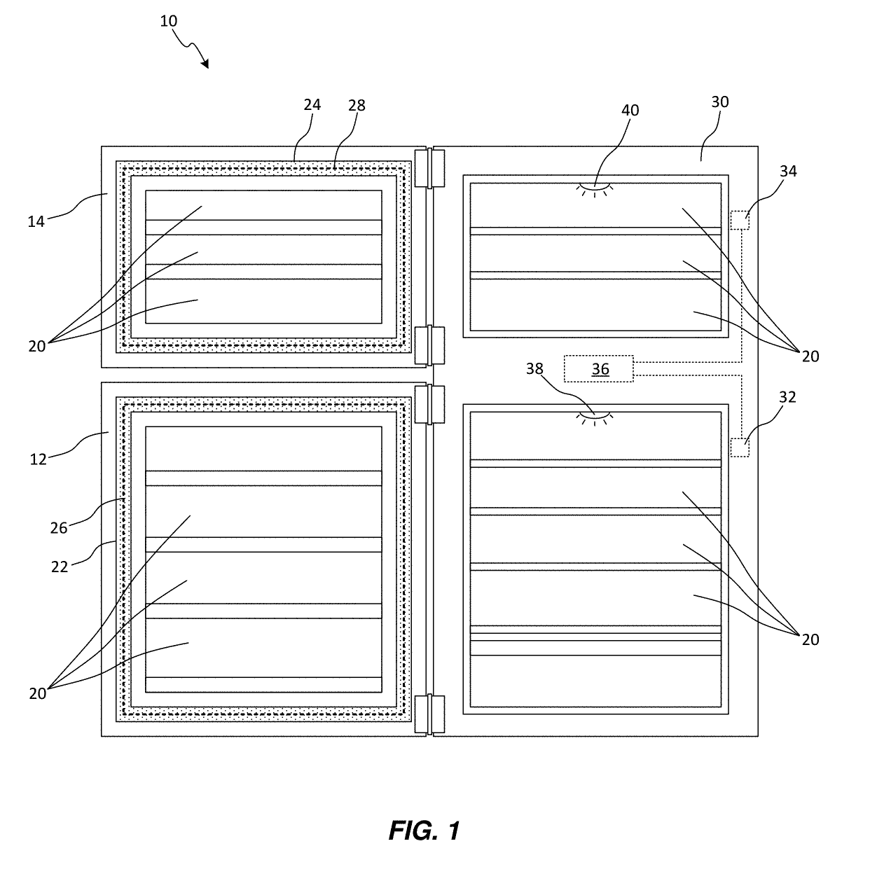

Referring to FIG. 1, a front view illustrating a refrigerator 10 in accordance with an exemplary embodiment of the present disclosure is shown. A refrigerator door 12 and a freezer door 14 of the refrigerator 10 are shown in an open position. The refrigerator 10 is conventional in many respects and may include a refrigeration compartment 16 and a separate freezer compartment 18, each having one or more shelves, drawers, compartments, etc. (collectively referred herein as “storage spaces” 20). The inside of the refrigerator door 12 and/or the inside of the freezer door 14 may also include storage spaces 20. The refrigerator 10 illustrated in FIG. 1 is shown by way of example only, and it will be appreciated by those of ordinary skill in the art that various novel features of the present disclosure that will be described below may be similarly implemented in numerous other types of refrigeration appliances, including, but not limited to, chest freezers, wine/beverage coolers, mini-refrigerators, walk-in coolers, etc.

The refrigerator door 12 and the freezer door 14 may include respective door gaskets 22, 24 attached to interior surfaces thereof. The door gaskets 22, 24 may have respective magnets 26, 28 disposed within them. The magnets 26, 28 may be flexible strip or tape magnetics that may extend through substantially the entire interiors of the door gaskets 22, 24, entirely surrounding the open fronts of the refrigeration compartment 16 and the freezer compartment 18, respectively. In various alternative embodiments, the magnets 26, 28 may extend around less than the entireties of the open fronts of the refrigeration compartment 16 and the freezer compartment 18.

When the refrigerator door 12 and the freezer door 14 are closed, the magnets 26, 28 may be attracted to the metallic frame 30 of the refrigerator 10, causing the door gaskets 22, 24 to be compressed between the frame 30 and each of the refrigerator door 12 and the freezer door 14. The door gaskets 22, 24 may thus seal the refrigeration compartment 16 and the freezer compartment 18 against the ingress of heat. The door gaskets 22, 24 and the magnets 26, 28 are conventional refrigerator components that will be familiar to those of ordinary skill in the art and will therefore not be described in any greater detail herein.

The refrigerator 10 may further include first and second tunneling magnetoresistance (TMR) door sensors 32, 34 disposed entirely within the frame 30. Specifically, the first TMR door sensor 32 may be positioned within the frame 30 such that when the refrigerator door 12 is closed, the magnet 26 in the door gasket 22 of the refrigerator door 12 is disposed in close proximity to (e.g., within 2 inches of) the first TMR door sensor 32. Similarly, the second TMR door sensor 34 may be positioned within the frame 30 such that when the freezer door 14 is closed, the magnet 28 in the door gasket 24 of the freezer door 14 is disposed in close proximity to (e.g., within 2 inches of) the second TMR door sensor 34. The first and second TMR door sensors 32, 34 may be operatively connected to a control unit 36 (e.g., a microprocessor, an application specific integrated circuit (ASIC), etc.) of the refrigerator 10 that is configured to control certain operations of the refrigerator 10 as further described below.

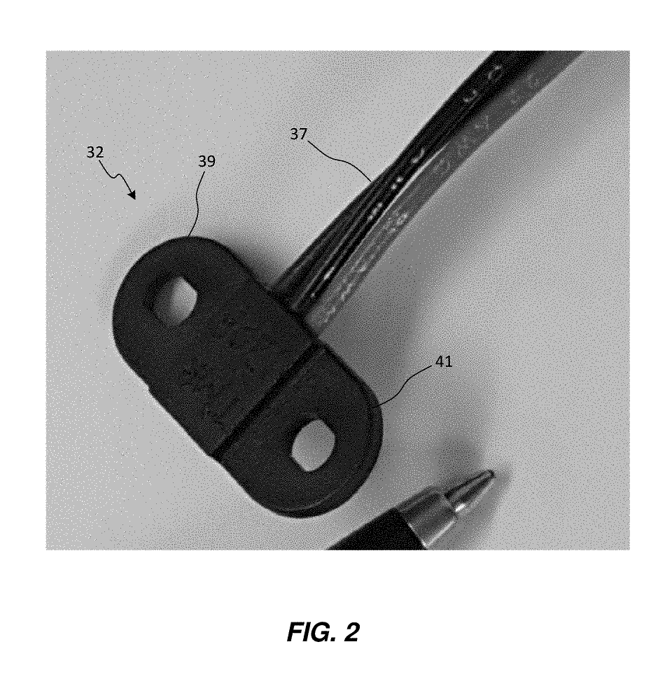

Referring to FIG. 2, a perspective view illustrating the first TMR door sensor 32 is shown. The second TMR door sensor 34 is not shown in FIG. 2, but it will be understood that the second TMR door sensor 34 may be substantially identical to the first TMR door sensor 32. As depicted in FIG. 2, the first TMR door sensor 32 may be a relatively compact and substantially planar component having electrical leads 37 extending therefrom for facilitating electrical connections to the control unit 36 (FIG. 1), for example. The first TMR door sensor 32 may further include mounting flanges 39, 41 for facilitating mounting of the first TMR door sensor 32 to the frame 30 of the refrigerator 10 (e.g., with mechanical fasteners), though it is contemplated that the mounting flanges 39, 41 may be omitted.

The first and second TMR door sensors 32, 34, which may be substantially identical, are formed of a magnetic multilayer film material that exhibits a change in resistivity as a function of applied magnetic field induction. Thus, when the refrigerator door 12 and the freezer door 14 are closed, the first and second TMR door sensors 32, 34 may exhibit relative increases in resistivity due to the relatively close proximities of the magnetic fields emanated by the magnets 26, 28. Conversely, when the refrigerator door 12 and the freezer door 14 are open, the first and second TMR door sensors 32, 34 may exhibit relative decreases in resistivity due to the absence (or near absence) of the magnetic fields emanated by the magnets 26, 28 proximate the first and second TMR door sensors 32, 34, respectively. Thus, the control unit 36 may, by monitoring the resistivities of the TMR door sensors 32, 34, determine whether the refrigerator door 12 and the freezer door 14 are open or closed and may perform certain operations accordingly. For example, when the refrigerator door 12 and/or the freezer door 14 are open, the control unit 36 may activate lights 38, 40 within the refrigeration compartment 16 and/or the freezer compartment 18, respectively. The lights 38, 40 may be deactivated when the refrigerator door 12 and the freezer door 14 are closed. Additionally or alternatively, a compressor (not shown) of the refrigerator 10 may be activated and deactivated depending on the positions of the refrigerator door 12 and the freezer door 14. The present disclosure is not limited in this regard, and it is contemplated that various other operations may be performed or effectuated by the control unit 36 when the refrigerator door 12 and/or the freezer door 14 are determined to be open or closed.

It will be appreciated by those of ordinary skill in the art that the TMR door sensors of the present disclosure provide numerous advantages. For example, the TMR door sensors of the present disclosure are solid state components that have no moving parts, and are therefore not susceptible to mechanical wear. The TMR door sensors of the present disclosure therefore have superior reliability relative to conventional pushbutton door switches. Additionally, the TMR door sensors of the present disclosure can be housed entirely within the frame of a refrigerator and are therefore hidden from view, thus preserving the aesthetic appearance of a refrigerator. Still further, the TMR door sensors of the present disclosure cooperate with existing magnets within conventional refrigerator door gaskets, and therefore do not require any additional components to be installed within the doors of refrigerators.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

We claim:

1. A refrigeration appliance comprising:
a frame defining a refrigeration compartment;
a door connected to the frame and having a door gasket with a magnet disposed therein, the door movable between an open position in which the refrigeration compartment is accessible and a closed position in which the door covers the refrigeration compartment; and
a tunneling magnetoresistance (TMR) door sensor disposed within the frame, wherein the magnet is positioned adjacent the TMR door sensor when the door is in the closed position.

2. The refrigeration appliance of claim 1, wherein, when the door is in the closed position, the magnet holds the door gasket to the frame and the door gasket forms a seal between the door and the frame.

3. The refrigeration appliance of claim 1, wherein, when the door is in the closed position, the magnet is located within 2 inches of the TMR door sensor.

4. The refrigeration appliance of claim 1, wherein the door is a refrigerator door, the TMR door sensor is a first TMR door sensor, and the frame further defines a freezer compartment, the refrigeration appliance further comprising:
a freezer door connected to the frame and having a door gasket with a magnet disposed therein, the freezer door movable between an open position in which the freezer compartment is accessible and a closed position in which the freezer door covers the freezer compartment; and
a second TMR door sensor disposed within the frame, wherein the magnet within the door gasket of the freezer door is positioned adjacent the second TMR door sensor when the freezer door is in the closed position.

5. The refrigeration appliance of claim 1, further comprising a control unit connected to the TMR door sensor and to a light within the refrigeration compartment, wherein the control unit is adapted to detect a decrease in a resistivity of the TMR door sensor and resultantly activate the light when the door is opened from the closed position.

6. The refrigeration appliance of claim 1, further comprising a control unit connected to the TMR door sensor and to a light within the refrigeration compartment, wherein the control unit is adapted to detect an increase in a resistivity of the TMR door sensor and resultantly activate the light when the door is closed from the open position.

7. The refrigeration appliance of claim 1, further comprising a control unit connected to the TMR door sensor and to a compressor of the refrigeration appliance, wherein the control unit is adapted to detect a decrease in a resistivity of the TMR door sensor and resultantly deactivate the compressor when the door is opened from the closed position.

8. The refrigeration appliance of claim 1, the TMR door sensor further comprising a mounting flange extending therefrom and fastened to the frame.

9. The refrigeration appliance of claim 1, wherein the magnet is a flexible magnetic strip.

10. The refrigeration appliance of claim 1, wherein TMR door sensor includes a magnetic multilayer film material that exhibits a change in resistivity as a function of applied magnetic field induction.

11. The refrigeration appliance of claim 1, wherein the magnet entirely surrounds an open front of the refrigeration compartment.

12. A refrigeration appliance comprising:
a frame defining a refrigeration compartment;
a door connected to the frame and having a door gasket with a magnet disposed therein, the door movable between an open position in which the refrigeration compartment is accessible and a closed position in which the door covers the refrigeration compartment and the door gasket forms a seal between the door and the frame, the magnet holding the door gasket to the frame in the closed position;
a tunneling magnetoresistance (TMR) door sensor disposed within the frame, wherein the magnet is positioned adjacent the TMR door sensor when the door is in the closed position; and
a control unit connected to the TMR door sensor and to a light within the refrigeration compartment, wherein the control unit is adapted to detect a decrease in a resistivity of the TMR door sensor and resultantly activate the light when the door is opened from the closed position.

13. The refrigeration appliance of claim 12, wherein, when the door is in the closed position, the magnet is located within 2 inches of the TMR door sensor.

14. The refrigeration appliance of claim 12, wherein the door is a refrigerator door, the TMR door sensor is a first TMR door sensor, and the frame further defines a freezer compartment, the refrigeration appliance further comprising:
a freezer door connected to the frame and having a door gasket with a magnet disposed therein, the freezer door movable between an open position in which the freezer compartment is accessible and a closed position in which the freezer door covers the freezer compartment; and
a second TMR door sensor disposed within the frame, wherein the magnet within the gasket of the freezer door is positioned adjacent the second TMR door sensor when the freezer door is in the closed position.

15. The refrigeration appliance of claim 12, wherein the control unit is adapted to detect an increase in a resistivity of the TMR door sensor and resultantly deactivate the light when the door is closed from the open position.

16. The refrigeration appliance of claim 12, further comprising a compressor connected to the control unit, wherein the control unit is adapted to detect a decrease in a resistivity of the TMR door sensor and resultantly activate the compressor when the door is opened from the closed position.

17. The refrigeration appliance of claim 12, the TMR door sensor further comprising a mounting flange extending therefrom and fastened to the frame.

18. The refrigeration appliance of claim 12, wherein the magnet is a flexible magnetic strip.

19. The refrigeration appliance of claim 12, wherein TMR door sensor includes a magnetic multilayer film material that exhibits a change in resistivity as a function of applied magnetic field induction.

20. The refrigeration appliance of claim 12, wherein the magnet entirely surrounds an open front of the refrigeration compartment.
